(19) United States
(12) Patent Application Publication
(10) Pub. No.: US 2006/0198987 A1
(43) Pub. Date: Sep. 7, 2006

(54) Multiple layer laminate

(75) Inventors: Jakob Grob, Mastrils (CH); Paul Smith, Zurich (CH); Kirill Feldman, Zurich (CH)

Correspondence Address: PILLSBURY WINTHROP SHAW PITTMAN, LLP, P.O. BOX 10500, MCLEAN, VA, 22102, US

(73) Assignees: LANDQART, 7302 Landquart (CH); EIDGENOSSISCHE TECHNISCHE HOCHSCHULE ZURICH, 8092 Zurich (CH)

(21) Appl. No.: 10/547,099

(22) PCT Filed: Dec. 30, 2003
(86) PCT No.: PCT/CH03/00850

§ 371 Date: Feb. 21, 2006

(30) Foreign Application Priority Data
Feb. 27, 2003 (CH) 301/03
May 28, 2003 (CH) 963/03

(51) Int. Cl. B32B 3/10

(52) U.S. Cl. 428/137

(57) ABSTRACT

The invention relates to a multiple layer laminate such as a printing carrier, especially in the form of antifalsification paper such as bank notes. Said multiple layer laminate or more precisely the printing carrier comprises at least one plastic layer (22) having an upper side (20) and a lower side (21), an upper paper layer (11) which is connected to the upper side (20) of the plastic layer (22), and optionally a lower paper layer (12) which is connected to the lower side (21) of the plastic layer (22). The aim of the invention is to achieve an especially intimate connection between the individual layers, with simultaneously good printability and with similar haptic characteristics such as those of pure paper carriers. To this end, a thermoplastic polymer material is used as the plastic layer (22), and the connection between the paper layers (11, 12) and the plastic layer (22) is ensured, essentially without additional bonding agents, by means of penetration regions (13, 14) in which parts of the plastic layer (22) are melted with the mass of fibre composite of the paper layers (11, 12). To this end, the penetration regions (13, 14) essentially do not extend to the surfaces of the paper layers opposing the plastic layer (22).

### FIELD OF THE INVENTION

The present invention relates to a multiple layer laminate which can be used, for example, as print substrates, in particular as security paper, but also as packaging material, covering material, card substrate, etc. The multiple layer laminate comprises at least one plastic layer having a top and a bottom, an upper paper layer bonded to the plastic layer and present on the top of the plastic layer, and optionally a lower paper layer bonded to the plastic layer and present on the bottom of the plastic layer.

### PRIOR ART

Combinations of paper and plastic in a laminate have a variety of uses. Particularly, the resistance of paper is increased by such a laminate (tensile strength, resistance to soiling, etc.). Typical uses of such laminates are, for example, packaging materials, printed or unprinted, covering materials, such as tablecloths, inlays for drawers, etc., gift-wrapping paper, etc. However, such laminates are also used as print substrates, for example as cover sheets for journals, as greeting cards, as a substrate for maps and, to date however, in a small quantity, as security paper, particularly as bank notes. Typically, the plastic layer and the paper layer are bonded by means of an adhesion promoter.

The discussion over many years about the advantages and disadvantages of paper and polymer materials as substrates for bank notes has now reached a mature phase. Although even today the polymer substrates do not account for more than a few percent of the market share of the bank note market and their introduction has in some cases been considered as the wrong decision, certain properties of the bank notes comprising polymer material have been regarded as progress and could expediently supplement the property portfolio of the successful paper notes, provided that a synthesis of the two products were to be technically conceivable.

In addition to the security of the novel substrate against falsification, further target parameters are moreover the printability by conventional bank note printing processes and the compatibility with the conventional sorting machines and automatic teller machines, but also further security features which are recognizable without aids or only with simple aids.

A discussion about the advantages and disadvantages of the paper substrate compared with the polymer substrate has taken place in recent years simultaneously with this development. The plastic notes which in particular have their core market in the Australian market have, on the other hand, the advantage of more favorable antiaging behavior in the sense of mechanical stability and antisoiling behavior. In addition, a transparent window, which has not been demonstrated to date in this form in paper notes, is frequently integrated in the polymer notes. The transparent window has been classed in the discussion as a first-level feature of great value but, in the judgment of some experts, is the only polymer-typical security feature of value.

Although the polymer notes have to date won only a few percent of the bank note market, they have exerted a considerable pressure on the market participants and also promoted other manufacturers to launch synthetic or semisynthetic substrates, without however generating a market success to a noticeable extent. In the central banks, there prevails today predominantly the opinion that the future nevertheless belongs to paper, but the latter should in a further stage of evolution additionally acquire certain desirable properties of the polymer. In this context, it should be noted that some bank note publishers have revised their decision regarding the introduction of polymer notes once again in favor of paper. Together with the need for new first-level features, the desire for a paper note with possible integrated transparent window and perhaps further first-level features is clearly evident. Depending on use (frequency of use, climate, etc.), desires for high tensile strength and good antisoiling behavior are also evident.

The conventional bank note papers are traditionally based on cotton as the main fiber raw materials. In addition, flax, synthetic fibers and linen are also admixed for increasing the mechanical strengths. These are not only renewable raw materials; in the case of combed cotton materials, a byproduct of the spinning industry is additionally put to an expedient use, which only reinforces the sustainability of bank note paper production from the ecological point of view. With the aid of additives, the high values for wet strength are achieved.

Since the 70s, multitone watermarks have been customary in the bank note sector and have been constantly refined in the course of the years. Since the introduction of the cylinder mold technology, security filaments in paper have been part of the prior art. Here too, new variants, such as window filaments, broad filaments and personalized filaments were continuously introduced. Security features which can be introduced by simple addition to the fiber in the manufacturing process, such as, for example, pigments or tracer fibers, are easy to integrate into the paper but on the other hand can be imitated in general only with difficulty by the falsification process, which is based on printing processes. This is the reason for the value of paper for security applications and has long made it a preferred substrate for bank notes.

Owing to the open pore structure of the paper substrates, the latter are susceptible to soiling and therefore have a limited life with respect to their circulation time as bank notes. Since the end of the 90s, this problem has been encountered with bank note substrates which have a sealed surface with the aid of a thin coating. A disadvantage is often insufficient matching of printing inks and surface coatings, which in turn also works against a longer life expectancy of the bank notes.

Initial attempts to introduce a polymer-based bank note were made for Haiti. A further attempt is known for the Isle of Man. However, owing to its extremely hydrophobic properties, the material suffers from a considerable susceptibility to soiling with regard to oleophilic substances.

The efforts in Australia, where such bank notes are still in use today, can be regarded as having been successful to a certain extent, but the success would not be conceivable without the printing inks specifically developed for this substrate. However, the additives required for adapting the inks to these specific conditions prevent the provision of certain tones.

A possible reason for the relatively modest market success of the polymer substrate is the small number overall of safety features which have been demonstrated at all with this material. As already mentioned, only the transparent window would be demonstrable here as a significant feature. The window part of the substrate permits novel security features which require transparent areas. On the other hand, the additional cost for printing and the high substrate costs lead to a total cost which can scarcely be justified by the longer life even in the case of notes under considerable stress.

Below, some of the advantages of paper and polymer substrates (in particular biaxially oriented polypropylene PP) for use as bank note substrates are listed in a very compact form:

Advantages of paper:
handle and sound accepted by a high degree by the public
possibility of introducing watermarks
easy integratability of fibrous material (colored fibers) in concealed or evident form
functional additives or (hydrophilic) polymers can be incorporated in a simple manner
resistant to conventional solvents
very good printability and printing ink adhesion
good thermal stability
low, acceptable price

Advantages of plastic (PP) substrate:
relatively good antisoiling behavior owing to the lower hydrophilicity
easy integratability of transparent or at least exposed plastic regions
excellent tensile strength at temperature of use

Thus, the polymer has in particular an advantage with respect to the possibility of integratability of a “window”, the mechanical strengths at room temperature and the antisoiling behavior. It is therefore necessary to optimize the paper substrate and to a certain extent to permit the introduction of the positive properties of polymers into the paper substrate.

An attempt to combine the positive properties of paper-based print substrates with the positive properties of plastic film is described in U.S. Pat. No. 5,449,200. It is proposed there to provide a plastic layer between two paper layers, this plastic layer being printed so that the corresponding imprint is visible only in transmitted light but not in reflected light. The bond between plastic layer and the paper layers is produced by laminating the layers, an adhesive being used. The problem with this approach is the unacceptably high risk of delamination of such substrates when they are put into circulation.

### SUMMARY OF THE INVENTION

It is accordingly the object of the invention to provide a novel multiple layer laminate, for example as a novel print substrate, but in particular not exclusively for security applications but also for other applications, such as, for example, as packaging material, label material, covering material, envelope material, etc. The multiple layer laminate or preferably the print substrate should as far as possible combine at least some of the positive properties of a paper substrate with the positive properties of plastic substrates without exhibiting new disadvantages. A multiple layer laminate or a print substrate in question comprises at least one plastic layer which may optionally have a multilayer form, with a top and a bottom, and at least one upper paper layer on the top of the at least one plastic layer and bonded to the plastic layer. Optionally, a lower paper layer bonded to the plastic layer can also be arranged on the bottom of the plastic layer, i.e. the plastic layer can be surrounded on both sides by paper.

This object is achieved if the plastic layer comprises one (or more) thermoplastic polymeric materials, and if the bond between the paper layer and the plastic layer is ensured substantially without additional adhesion promoter, in each case by penetration zones in which parts of the plastic layer are fused with the material of the fiber composite of the paper layer, the penetration zone substantially not extending completely to the surfaces of the paper layer which face away from the plastic layer. In the case of paper layers arranged on both sides of the plastic layer (upper and lower paper layer), such a fusion with penetration zones to both paper layers is preferably present. The penetration zones can, however, also pass through up to the respective surface of the paper layers and thus in each case more or less completely impregnate the paper layers.

The core of the invention therefore consists in the surprising discovery that paper layers and thermoplastic layers, in spite of their very different chemical behavior (industrial thermoplastic versus cellulose) can be partly fused to one another, an extremely stable and intimate bond forming between paper layer and plastic layer. In this context, fusion means that the thermoplastic flows around the cellulose and embeds this as a matrix. While in fact laminates according to the prior art using reactive adhesives or solvent-based adhesives as adhesion promoter between paper and plastic layer have the problem of delamination in high-stress uses, such as, for example, as packaging material, label material, covering material or envelope material and in particular in the case of the extremely high-stress use as bank notes, this can be prevented by a (multiple layer) laminate according to the invention. The laminate according to the invention provides a bond by virtue of the fact that uppermost layers of the plastic layer are directly fused to lowermost layers of the paper layers, i.e. that the fibers of the paper layers are at least partly embedded in a plastic matrix. The resulting penetration zones in the respective boundary regions between plastic layer and paper layers are adjusted so that the plastic partly penetrates the papers layer but without extending completely to that surface of the paper layer(s) which faces away from the plastic layer. This ensures that the haptic properties of the paper are retained on one side of the resulting print substrate, and that the printing properties of the multiple layer laminate or print substrate are likewise substantially retained on the other side. If in fact plastic penetrates the paper substrate completely to the surface or close to the surface, not only does the handle change but also the porosity (this leads, so to speak, to a seal), which may considerably complicate the adhesion of printing inks or inks and may facilitate the abrasion thereof.

On the other hand, the penetration of the thermoplastic into the paper layers also leads to antisoiling behavior, which is entirely desirable. The antisoiling properties together with the haptic properties and the printing properties can thus be controlled via the degree of penetration of the thermoplastic into the paper matrix.

As already mentioned, the plastic layer may be composed of a single layer of a single material but can also be composed of a multiple layer laminate (multilayer structure), it being possible for individual layers to consist of different thermoplastic materials (differing polymers or identical polymers having different properties). In particular, for example, thermoplastics which have a flow behavior differing from or better than (lower molecular weight, lower glass transition temperature or lower flow temperature) that of the central layers can be used as layers which come into direct contact with the paper.

According to a first preferred embodiment of the present invention, at least one of the paper layers is paper which was produced in a vat machine. Alternatively, it is also possible to use a Fourdrinier machine or uphill wire machine. This is preferably, for example, a typical bank note paper, i.e. a paper which was produced using cotton (typically main fiber raw material) and/or flax and/or linen as fiber raw material.

The desired properties with respect to fusion between plastic layer and paper layers can preferably be achieved by using, as material for the plastic layer, a polymeric material having a glass transition temperature or melting point in the range from 50 to 250° C., preferably in the range from 75 to 225° C., or in the range from 100 to 200° C., particularly preferably from 120 to 180° C. In principle, it should be a thermoplastic which begins to melt or soften at a temperature at which the paper is not damaged. For example, in the case of polymeric material, it may be a transparent, for example partly amorphous or completely amorphous polyamide, a polypropylene or polyethylene, particularly preferably a polyamide based on aliphatic and cycloaliphatic building blocks. Transparent polymeric material is advantageous particularly when the possibility of clear transparent windows or at least transparent regions free on one side is intended. However, it is also possible to use as polymeric material a colored or nontransparent material, and semitransparent materials are also conceivable. Such polymers are obtainable, for example, from EMS-CHEMIE (Switzerland) under the trade name GRILAMID®, GRILON® or GRIVORY®. These materials can, if required, be appropriately colored and/or can contain further functional components. Suitable dyes are dyes in the visible range, but also fluorescent or phosphorescent dyes. Moreover, the thermoplastic material may simultaneously contain magnetic components, electrically conductive components, thermochromic or photochromic components, UV absorbers, etc. or a plurality of these components.

In principle, the following polymers constitute suitable material for the plastic layer:

Polymers of monoolefins and diolefins, e.g. polypropylene, polyisobutylene, polybut-1-ene, poly-4-methylpent-1-ene, polyvinylcyclohexane, polyisoprene or polybutadiene, and polymers of cycloolefins, e.g. of cyclopentene or norbornene, polyethylene (which may optionally be crosslinked), e.g. high density polyethylene (HDPE), medium density polyethylene (MDPE), low density polyethylene (LDPE), linear low density polyethylene (LLDPE), (VLDPE) and (ULDPE).

Copolymers of monoolefins and diolefins with one another or with other vinyl monomers, e.g. ethylene/propylene copolymers, linear low density polyethylene (LLDPE) and blends thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene, such as COC), ethylene/1-olefin copolymers, the 1-olefin being produced in situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and salts thereof (ionomers) and terpolymers of ethylene with propylene and a diene, such as, for example, hexadiene, dicyclopentadiene or ethylidenenorbornene. Said homopolymers and copolymers may have any desired three-dimensional structure (stereostructure), such as, for example, syndiotactic, isotactic, hemiisotactic or atactic. Stereoblock polymers are also possible.

Polystyrene, poly(p-methylstyrene), poly(α-methylstyrene). Aromatic homopolymers and copolymers derived from vinylaromatic monomers, including styrene, α-methylstyrene, all isomers of vinyltoluene, in particular p-vinyltoluene, all isomers of ethylstyrene, propylstyrene, vinylbiphenyl, vinylnaphthalene and vinylanthracene and blends thereof. Homopolymers and copolymers may have any desired three-dimensional structure, including syndiotactic, isotactic, hemiisotactic or atactic. Stereoblock polymers are also included.

Copolymers, including the abovementioned vinylaromatic monomers and comonomers selected from ethylene, propylene, dienes, nitriles, acids, maleic anhydrides, maleimides, vinyl acetates and vinyl chlorides or acryloyl derivatives and mixtures thereof, for example styrene/butadiene, styrene/acrylonitrile, styrene/ethylene (interpolymers), styrene/alkylmethacrylate, styrene/butadiene/alkyl acrylate, styrene/butadiene/alkyl methacrylate, styrene/maleic anhydride, styrene/acrylonitrile/methyl acrylate; blends having a high impact strength and comprising styrene copolymers and other polymers, e.g. polyacrylates, diene polymers or ethylene/propylene/diene terpolymers; and block copolymers of styrene, such as, for example, styrene/butadiene/styrene, styrene/isoprene/styrene, styrene/ethylene/butylene/styrene or styrene/ethylene/propylene/styrene. Hydrogen-saturated aromatic polymers derived by hydrogen saturation of said polymers, in particular including polycyclohexylethylene (PCHE) prepared by the hydrogenation of atactic polystyrene (frequently designated as polyvinylcyclohexane (PVCH)).

Graft copolymers of vinylaromatic monomers, such as, for example, styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadienes; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers.

Halogen-containing polymers, such as, for example, polychloroprene, chlorinated rubbers, chlorinated and brominated copolymers of isobutylene-isoprene (halobutyl rubber), chlorinated or sulfochlorinated polyethylene, copolymers of ethylene and chlorinated ethylene, epichlorohydrin homo- and copolymers, in particular polymers of halogen-containing vinyl components, e.g. polyvinyl chlorides, polyvinylidene chlorides, polyvinyl fluorides, polyvinylidene fluorides, and copolymers thereof, such as, for example, vinyl chloride/vinylidene chloride, vinyl chloride/vinyl acetate or vinylidene chloride/vinyl acetate copolymers.

Polymers derived from α,β-unsaturated acids and derivatives thereof, such as, for example, polyacrylates and polymethacrylates; polymethyl methacrylates, polyacrylamides and polyacrylonitriles, made impact-resistant with butyl acrylate, copolymers of said monomers with one another and with other unsaturated monomers, such as, for example, acrylonitrile/butadiene copolymers, acrylonitrile/alkyl acrylate copolymers, acrylonitrile/alkoxyalkyl acrylates or acrylonitrile/vinyl halide copolymers or acrylonitrile/alkyl methacrylate/butadiene terpolymers.

Polymers derived from unsaturated alcohols and amines or from acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallylmelamine; and copolymers thereof with olefins.

Homopolymers and copolymers of cyclic ethers, such as, for example, polyalkylene glycols, polyethylene oxide, polypropylene oxide or copolymers thereof with bisglycidyl ethers.

Polyacetals, such as, for example, polyoxymethylene and those polyoxymethylenes which contain ethylene oxide as a comonomer; polyacetals modified with thermoplastic polyurethanes, acrylates or MBS.

Polyphenylene oxides and sulfides.

Polyurethanes derived from hydroxyl-terminated polyethers, polyesters or polybutadienes on the one hand and aliphatic or aromatic polyisocyanates on the other hand, and precursors thereof.

Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylenediamine and adipic acid; polyamides prepared from hexamethylenediamine and isophthalic and terephthalic acid as starting materials and with or without an elastomer as a modifier, for example poly-2,4,4-trimethylhexamethyleneterephthal-amide or poly-m-phenyleneisophthalamide; and also block copolymers of said polyamides with polyolefins, olefin copolymers, ionomers or chemically bonded or grafted elastomers; or with polyethers, for example with polyethylene glycol, polypropylene glycol or polytetramethylene glycol; and also polyamides or copolyamides modified with EPDM or ABS; and polyamides condensed during the preparation (RIM polyamide systems).

Polyureas, polyimides, polyamidoimides, polyetherimides, polyesterimides, polyhydantoins and polybenzimidazoles.

Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoate, and also block copolyetheresters derived from hydroxyl-terminated polyethers.

Polycarbonates and polyestercarbonates, polyketones, polysulfones, polyethersulfones and polyetherketones.

Crosslinked polymers derived from aldehydes on the one hand and phenols, ureas and melamines on the other hand, such as, for example, phenol/formaldehyde resins, urea/formaldehyde resins and melamine/formaldehyde resins.

Unsaturated polyester resins derived from copolyesters of saturated and unsaturated dicarboxylic acids, polyhydric alcohols and vinyl components as crosslinking agents, and also halogen-containing modifiers thereof having low flammability.

Crosslinked acrylic resins derived from substituted acrylates, e.g. epoxyacrylates, urethaneacrylates or polyesteracrylates.

Alkyd resins, polyester resins and acrylate resins crosslinked with melamine resins, urea resins, isocyanates, isocyanurates, polyisocyanates or epoxy resins.

Crosslinked epoxy resins derived from aliphatic, cycloaliphatic, heterocyclic or aromatic glycidyl components, for example products of diglycidyl ethers of bisphenol A and bisphenol F, which are crosslinked with conventional curing agents, such as, for example, with anhydrides or amines, with or without an accelerator.

Cellulose acetates, cellulose propionates and cellulose butyrates, or cellulose ethers, such as methylcellulose.

Blends of two or more of said polymers or copolymers are also possible.

As stated, the flowability of the thermoplastic used is important. Accordingly, it is alternatively also possible to use thermoplastics whose glass transition temperature or melting point is below the abovementioned glass transition temperature but which are in the solid state at the temperature of use of a product (e.g. bank note) and whose flow temperature is in the range from 50 to 250° C., preferably in the range from 75 to 225° C. or in the range from 100 to 200° C., particularly preferably from 120 to 180° C. Thus, for example in the case of polypropylene (PP), polyethylene (PE), polyvinylidene chloride (PVDC) or polyvinylidene fluoride (PVDF).

A further preferred embodiment is distinguished by the fact that the paper layers have a basis weight in the range from 50 to 500 g/m² or even from 5 to 500 g m², preferably in the range from 20 to 80 g/m², or from 10 to 80 g/m², particularly preferably in the range from 20 to 50 g/m². Preferably, the plastic layer has a thickness in the range from 5 to 500 μm, preferably in the range from 10 to 80 μm, particularly preferably in the range from 20 to 50 μm. The print substrate as a whole should have a basis weight in the range from 15 to 1500 g/m² or from 50 to 500 g/m², preferably in the range from 80 or 60 to 180 or to 200 g/m², particularly preferably in the range from 90 to 120 g/m² or from 80 to 150 g/m².

Very particularly advantageous in relation to the proposed multiple layer laminate or print substrate is the fact that it can be combined with the multiplicity of security features known from the area of the pure paper substrates. For this purpose, such security features can be simply incorporated into at least one of the paper layers either before, during or after the lamination process. Suitable security features are a very wide range of methods and types, very generally, for example, security features comprising corresponding information media of an optical, electronic, electrical or magnetic nature, for example watermarks, in particular gray step watermarks, security filaments, so-called optically variable devices (OVDs), colored fibers, security pigments, iridescent color applications, microperforations, microprints, offset, gravure printing, magnetic stripes, chips, etc. The plastic layer may also be provided with security features. In the simplest embodiment, this may be an imprint which is not visible in reflected light owing to the paper layers present on top (and accordingly, for example, also cannot be reproduced using a copier), but which can be recognized in transmitted light. However, in the case of the plastic layer, other security features, in particular in the region of the below-mentioned windows, are suitable, for example fluorescent regions, polarizing regions, polarized fluorescent regions, polarized absorbent regions, photochromic regions, holograms, embossing, etc.

The multiple layer laminate according to the invention or the print substrate according to the invention has the unusual advantage that, in spite of appearance and handle like paper, it offers the possibility of incorporating additional information as security features, in particular security features in the form of or incorporated in windows.

In this context, a window is understood as meaning not exclusively a transparent region which is bounded all round (by paper); a window in the context of the present invention can be bounded all round but, in the final intended multiple layer laminate or print substrate, may also be arranged at the edge in such a way that the window region directly borders the edge. A window is in principle also to be understood as meaning not exclusively a cut-out which contains a transparent region but also cut-outs which expose colored and, for example, nontransparent or partly transparent, fluorescent, phosphorescent, polarizing, optically refractive or holographic plastic regions. Also possible in the case of multiple layer laminates which have paper on both sides are cut-outs in which only the paper is exposed on one side of the plastic layer(s). Also possible are corresponding combinations in which, for example, the cut-outs in the two paper webs do not coincide so that, on the one hand, regions in which the plastic layer is accessible from both sides form, and, on the other hand, at least one further region in which the plastic layer is accessible only from one side.

The window itself and many of the information media or security features integrated in the window constitute so-called first-level security features since they can be easily verified by the human eye on the street without the aid of technical devices. Such security features, if they are virtually impossible to reproduce, have an extremely high value. In the case of a print substrate according to the invention, it is possible to provide a window by virtue of the fact that at least one of the paper layers has a cut-out right through so that the plastic layer is exposed in this region (one-sided window, for example, for a view of a safety feature of the plastic layer). A properly transparent window with the use of a transparent plastic layer is provided by virtue of the fact that both paper layers have such a cut-out in at least a partly overlapping manner with formation of a window. It proves to be interesting from the point of view of security to enable such cut-outs to have an irregular edge and/or fluid transitions without edges between paper and window. Surprisingly, in the case of the print substrate according to the invention, the problems of delamination of paper layers from the plastic layer in the edge region, which otherwise occur particularly in relation to windows having a complex contour, are virtually completely absent.

In order to be able to ensure a homogeneous thickness of the multiple layer laminate or print substrate, it is also possible to insert a further plastic layer having the same or a similar contour as the window into the window in the region of the cut-out during production.

It is found that in principle in particular the region of the window and the cut-out on one side are particularly suitable for the arrangement of security features in the plastic film. Thus, for example, security features having polarized properties can be incorporated into these regions. Such windows are also very suitable for so-called “self-verifying” properties, i.e. the verification of other security features with the aid of the window. Thus, for example, polarizing properties of a security feature can be verified by placing a window region which likewise has polarizing transmission properties above the security feature by folding the bank note.

Further preferred embodiments of the printed substrate according to the invention are described in the dependent claims.

The present invention furthermore relates to a process for the production of a multiple layer laminate, such as, for example, of a print substrate, as described above. In a preferred procedure, the at least one paper layer is at least partly fused to the plastic layer in a laminator, a temperature in the range from 50 to 250° C., preferably in the range from 75 to 225° C., or in the range from 100 to 200° C., particularly preferably from 140 to 180 degrees, being used. Preferably, a pressure in the range from 10 Pa to 10 MPa, preferably from 1 kPa to 10 MPa, or from 1 kPa to 5 MPa, particularly preferably in the range from 0.5 MPa to 2 MPa, is also used. It is possible to run a program by first increasing the temperature and then pressure, or vice versa. The process either can take place batchwise in presses or can be carried out continuously. In the continuous procedure, the individual substrates are appropriately fed by means of rollers, and the laminator is a roller laminator, the plastic layer and optionally also security features, such as security filaments, being fed centrally and the two paper layers from the top or from the bottom.

If a window is to be made, a cut-out unit in which the cut-outs are made in the paper webs in register, for example by means of a laser, water jet, punching or the like, must be installed in the process.

Further preferred embodiments of the process according to the invention are described in the further dependent claims.

In addition, the present invention relates to the use of such a print substrate as security paper, in particular as bank note, check, ticket, certificate, share document or bond document, documents, identity papers, packaging material, label material, envelope material, covering material, etc.

### BRIEF EXPLANATION OF THE FIGURES

The invention is to be explained in more detail below with reference to embodiments in relation to the drawings.

FIG. 1 shows a multiple layer laminate comprising a middle plastic layer according to the prior art, in section;

FIG. 2 shows a multiple layer laminate comprising a middle plastic layer according to the invention, in section;

FIG. 3 shows a plan view of a multiple layer laminate;

FIG. 4 shows a section according to FIG. 2 in an alternative representation;

FIG. 5 shows a section according to FIG. 4, edge fusions being shown;

FIG. 6 shows a) a section through an embodiment comprising only one paper layer and cut-outs in the edge region, b) a section according to FIG. 4, at least one window bordering the edge being shown and paper being arranged on both sides; c) a plan view of parts of a substrate according to FIG. 6b);

FIG. 7 shows a section through a multiple layer laminate comprising various cut-outs;

FIG. 8 shows a section through a multiple layer laminate comprising a multiplicity of layers;

FIG. 9a)-c) shows sections from multiple layer laminates comprising different penetration depths, d) a section through a multiple layer laminate comprising locally different penetration depths;

FIG. 10a), b) shows sections through multiple plastic layers;

FIG. 11 shows a plan view a) and a section b) through a multiple layer laminate comprising discontinuities in the plastic layer;

FIG. 12 shows a schematic diagram of the arrangement of the layer structure prior to lamination;

FIG. 13 shows a diagram of the tests for determining the strength of the bond between the paper layers and the plastic layer;

FIG. 14 shows a schematic diagram of the starting material for the production of a print substrate with edge fusion;

FIG. 15 shows a plan view of a multiple layer laminate comprising a window or a cut-out which completely separates the paper layers from one another on one side;

FIG. 16 shows a plan view of an embodiment comprising a self-verifying security feature; and

FIG. 17 shows a plan view a) and a section b) through a further embodiment comprising self-verifying security features.

### DESCRIPTION OF THE PREFERRED EMBODIMENTS

FIG. 1 shows a section through a print substrate in the form of a security paper 1 according to the prior art. Such a multiple layer laminate (for example in the form of a security paper) 1 is described, for example, in U.S. Pat. No. 5,449,200. It is a layer structure comprising a central plastic layer 4 which is covered on both sides by a paper layer 2 and 3. The adhesion promoter used for fastening the paper layers to the plastic layer 4 is a UV-curable reactive adhesive, which is recognizable as separate layer 5. Such layer structures according to the prior art have the problem that, particularly when used very intensively, as is usual in the case of bank notes, they have the tendency to delaminate, i.e. after a certain time in circulation the paper layers 2, 3 begin to become detached from the plastic layer 4. This delamination is the result of, inter alia, the frequent folding of the bank notes.

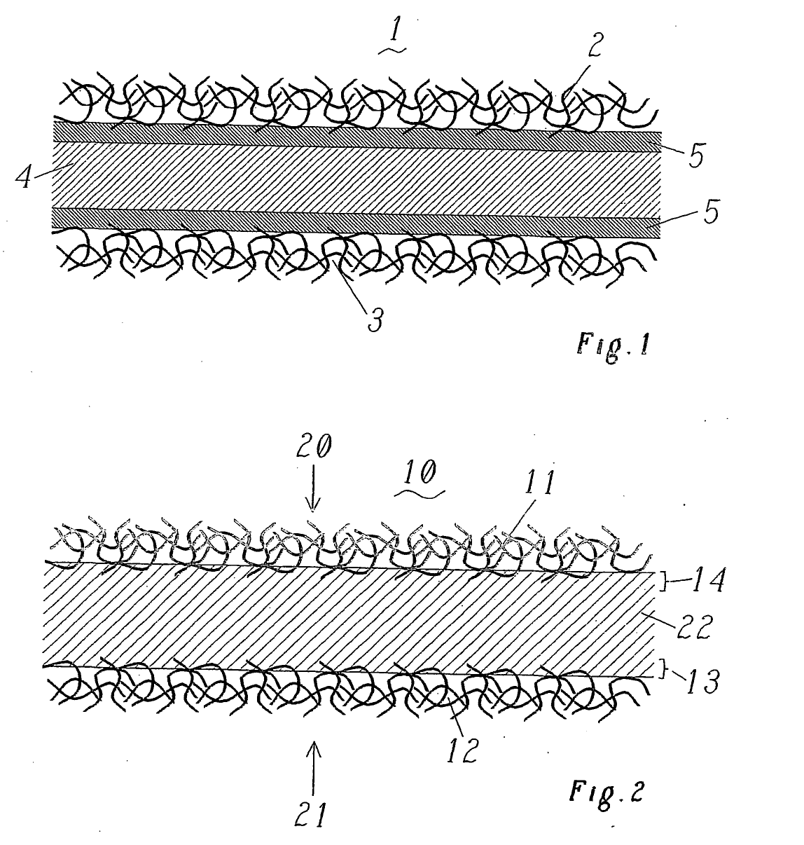

FIG. 2 shows a print substrate 10 according to the invention. In this case, a central plastic film or plastic layer 22 comprising a transparent thermoplastic (including multilayer thermoplastic) is covered directly on the top 20 and on the bottom 21 with paper layers 11 and 12, respectively. Here, the plastic layer 22 is shown as a single layer but may also consist of a plurality of layers. An adhesive is not used for adhesion promotion, and in this case the bond between paper layers 11 and 12 and the plastic layer 22 is ensured by penetration zones 13 and 14. In these penetration zones 13, 14, the material of the plastic layer 22 penetrates the respective paper layer to a certain depth. A certain part of the paper layers is accordingly more or less completely embedded in a matrix of plastic so that an extremely stable and intimate bond between the individual layers is ensured. These so-to-speak “fused” zones 13 and 14 (the term of use is to be understood here as meaning that the plastic layer so-to-speak surrounds part of the paper layer as a matrix in these zones) need not, however, extend completely into the paper layers 11 and 12, since otherwise the surface properties of the paper layers are modified on the sides facing away from the plastic layer 22.

The paper layers 11 and 12 are, for example, a bank note-like paper having a basis weight of 40 g/m², but in principle a weight in the range from 20 to 50 g/m² or from 5 to 500 g/m² is possible. The papers layers 11 and 12 accordingly contain cellulosic materials, such as cotton, as main fiber material and are produced, for example, on a vat machine. The paper of these layers contains, for example, a gray step watermark, and particularly high security can optionally be ensured by arranging different watermarks in a registered manner in the two paper layers 11 and 12.

The plastic layer 22 is a film, for example having a thickness of 40 μm and comprising completely amorphous, transparent polyamide. Such films can be obtained, for example, from EMS-CHEMIE (Switzerland) under the trade name GRILAMID® TR90 LX or under the name GRIVORY® G21.

The multiple layer laminate or security paper according to FIG. 2 was produced by placing the three layers one on top of the other in a laminator and then heating for 30 seconds and then pressing at this temperature for 30 seconds. With the use of GRIVORY® G21, it was found that a temperature of 120° C. was sufficient for fusion with the paper, whereas a temperature of 180° C. was better when GRILAMID® TR90 LX was used. However, the use of GRILAMID® TR90 LX led to mechanically more stable substrates. In the phase of increased pressure, a pressure of about 1 MPa was employed (area of 0.2-0.2 m, 4 metric tons).

In a continuous roller process, a nip pressure in the range of 1-500 N/mm can be employed.

A comparison of the mechanical properties of the security paper according to FIG. 2 with the substrate of a Swiss 100 SFr. bank note is shown in table 1.

| Property | Unit | Laminate | 100 SFr. Note |
|---|---|---|---|
| Weight | g/m² | 105 | 91 |
| Thickness | μ | 115 | 113 |
| Spec. volume | cm³/g | 1.09 | 1.25 |
| Bursting pressure | kPa | 340 | 360 |
| Tensile strength | longitudinal | 117 | 106 |
| Tensile strength | transverse | 89 | 63 |
| Tensile strength | average | 103 | 84 |
| Number of folds | longitudinal | 11 000 | 2162 |
| Number of folds | transverse | 3750 | 2088 |
| Elmendorf (1 sheet) | longitudinal | 910 | 1000 |
| Elmendorf (1 sheet) | transverse | 1006 | 1200 |
| Stiffness, beam | longitudinal | 0.79 | 0.56 |
| Stiffness, beam | transverse | 0.53 | 0.25 |

It is evident that in particular the number of folds of the new security paper is considerably superior, and with respect to the appearance and the mechanical properties after complete wetting (washing machine test).

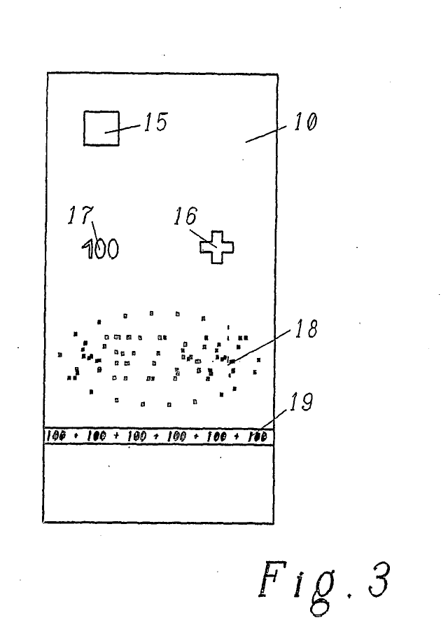

FIG. 3 shows a further substantial aspect of the present invention, namely that the laminate according to the invention can be particularly well combined with a very wide range of security features. Thus, security strips 19 can be incorporated into one paper layer or into both paper layers, and it is possible, as already mentioned further above, to provide in at least one of the paper layers watermarks 18 which are very readily visible in the case of transparent plastic layer 22. Moreover, and this is probably one of the striking properties of this laminate, it is possible to provide windows as security features. Window means that the paper layers have a cut-out in the region of the window, whereas the plastic layer is continuous. For example, reference numeral 15 indicates a rectangular window, but the window may also have a complex contour, as illustrated, for example, by the number (reference numeral 17) as well as by the Swiss cross (reference numeral 16).

Such windows also permit extremely interesting combinations of security features. Thus, for example, it is possible to design the plastic film 22 to be polarizing. If the bank note 10 is now folded so that the window 15 comes to rest above the character 17 (fold line parallel to the short side of the bank note), it is possible to see through both windows since the two polarization directions are parallel. If, however, the window 15 is placed above the window 16 by folding the upper left corner obliquely toward the bottom right, the two polarization directions are orthogonal and accordingly the two windows appear dark in transmitted light. More complex effects can be achieved if in addition different colors are brought into play, and if in addition different polarization directions are formed in the regions of different windows.

This geometrical arrangement of a security feature having polarizing properties and its verification means on a bank note is an independent innovation as such and independently of the laminate described here. It could also be used, for example, with the aid of a laminate having adhesive for fastening the paper webs.

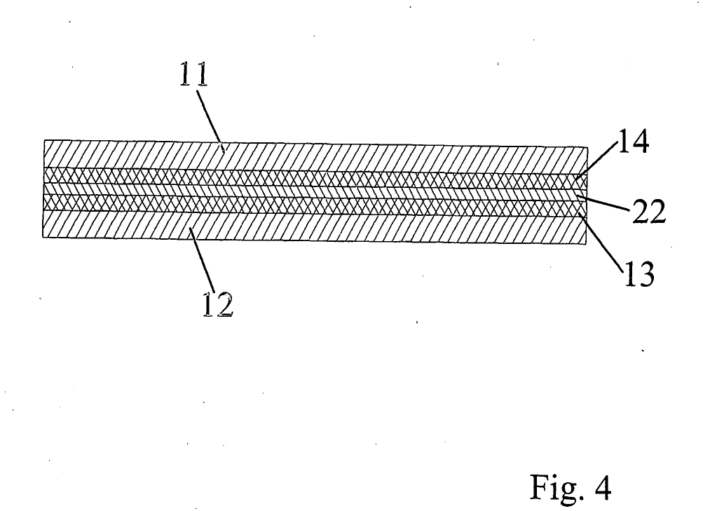

For further illustration, FIGS. 4 to 11 show different possibilities of the multiple layer laminates and the arrangement of the windows in a wider context.

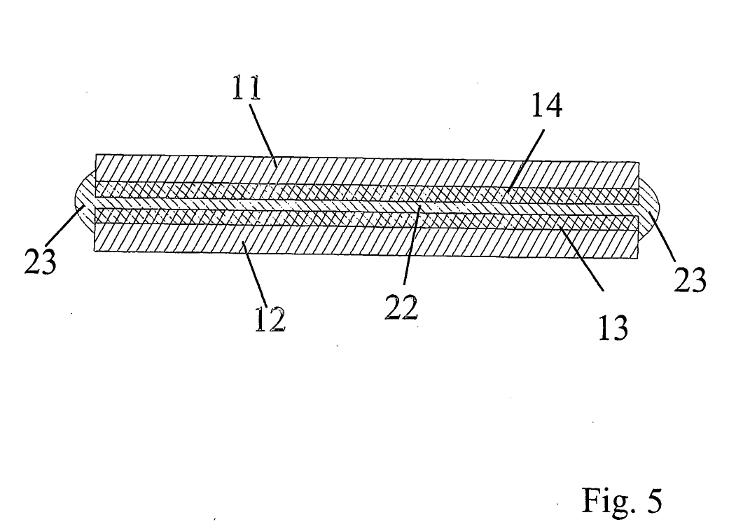

FIG. 4 shows, once again in a schematic diagram, a multiple layer laminate 21 analogous to FIG. 2, the different layers being shown hatched in this case. A particularly preferred embodiment is shown in FIG. 5. In this case, an edge fusion 23 is present at the edge of the object. Such an edge fusion 23 increases the tear resistance substantially. It can be obtained in various ways. For example, it is possible to cut out the plastic layer 22 slightly larger than the two paper layers 11 and 12. During the subsequent lamination, the projecting plastic region fuses with the edge, as shown in FIG. 5.

Alternatively, it is also possible to produce such a substrate in a continuous manner and then to cut it into appropriate pieces (for example into individual bank notes, greeting cards, etc.). This cutting can take place either with the use of elevated temperature (hot cutting tool) or optionally in combination with the use of elevated pressure. This is done so that, in the edge regions, the plastic layer 22 is pressed out slightly from the region of the paper layers 11 and 12, and an edge fusion 23 results.

Furthermore, it is possible to carry out an additional lamination of the edge after cutting to size in a separate process, once again parts of the plastic layer 22 being pressed out between the paper layers and giving rise to the edge fusion 23.

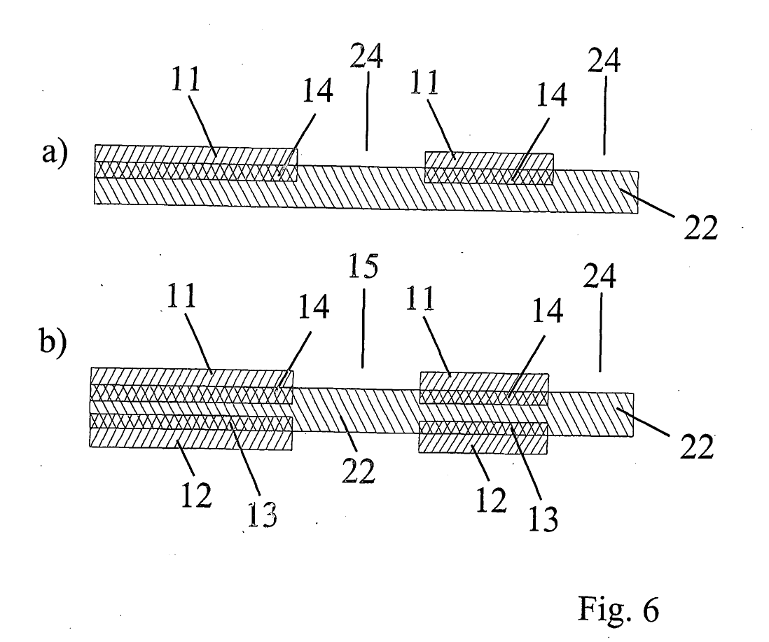

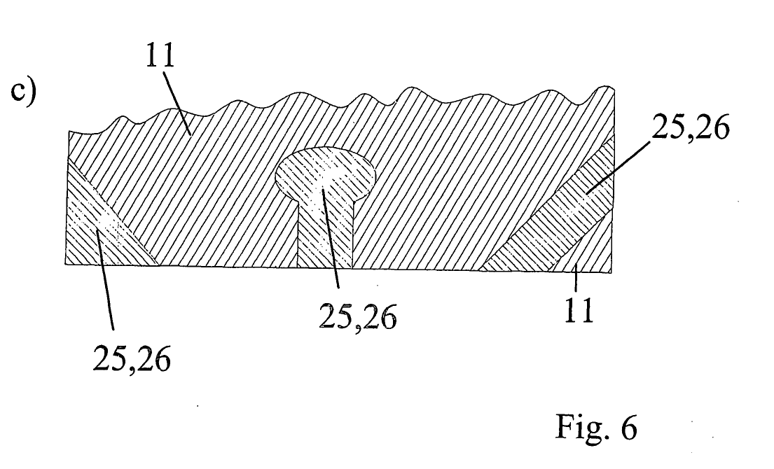

FIG. 6 shows that it is also possible to provide a paper layer only on one side. Moreover, it is shown that not only are windows completely enclosed by paper of the paper layer 11 possible but also edge regions 24, 25, 26 with exposed plastic. The shapes may be of different types, for example complete strips along the substrate at the edge, in which the plastic is exposed on either one side or both sides. Appropriate corners or any desired shape projecting into the print substrate (for example shown in the middle in FIG. 6c) are also possible.

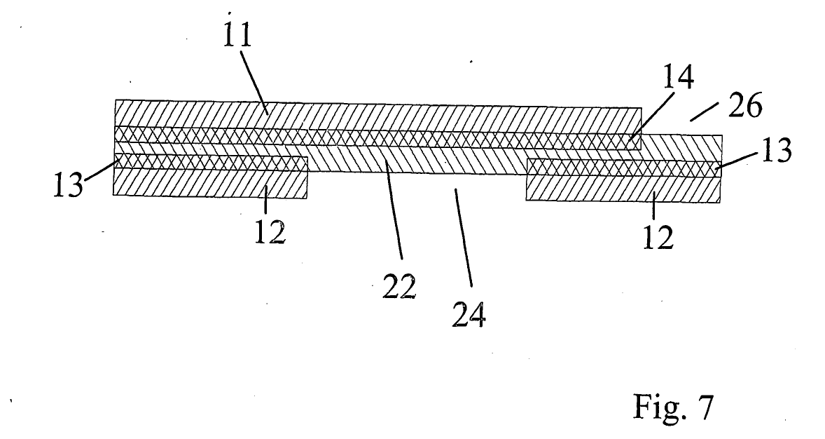

FIG. 7 serves to illustrate the fact that cut-outs 24, 26 are also possible in only one of the two paper layers 11 and 12. In these regions, the plastic film 22 is then exposed, and higher gloss is then visible in either region 24 or 26, but it is also possible in particular to ensure that special security features appear in these regions, which security features are present in or on (for example optically effective grid) the plastic film. It is also possible, for example in the middle cut-out 24 of FIG. 7 which is open up the bottom, to arrange a print or another security feature on the bottom of the paper layer 1 in the region of the cut-out 24. Such a print is then completely protected by the plastic film 22 on top.

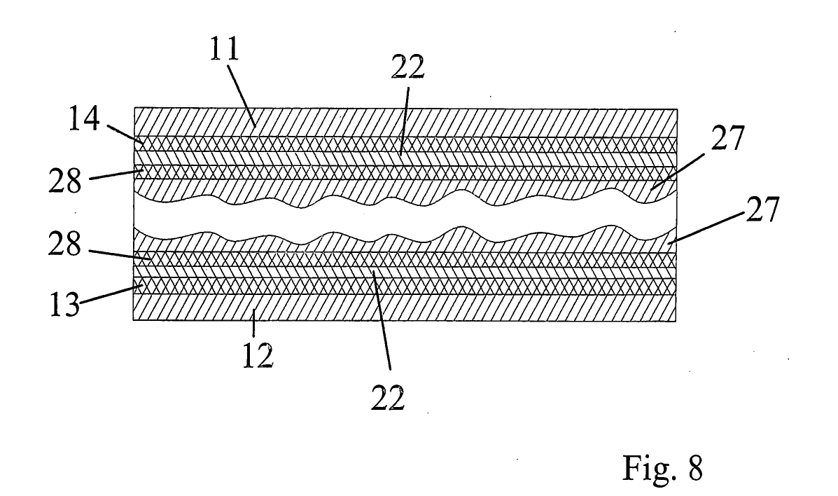

FIG. 8 serves to show that not only simple laminates comprising 2 or 3 layers are conceivable but that such a structure can also be built up in a multilayer manner comprising, for example, 4 or more layers.

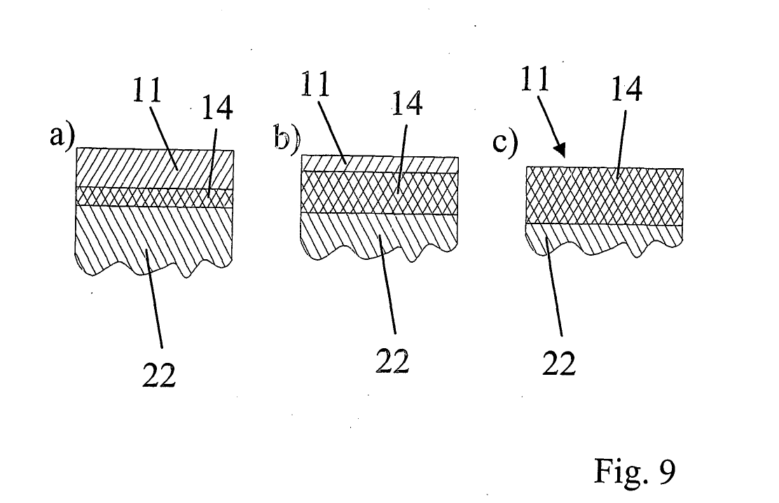

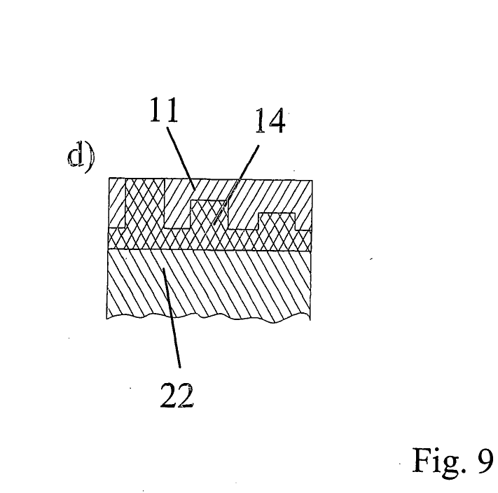

FIG. 9 shows how the penetration zones can have different depths. It is found that typically at least 10 micrometers of the paper should substantially not be penetrated by plastic for conventional printability (i.e. the upper region in FIGS. 9a and b which is not doubly hatched should have a thickness of at least 10 micrometers). Typically, the thickness of the paper layers which is not impregnated by plastic is less than 30 micrometers. For complete sealing, however, it is also possible to impregnate the paper layer completely with the plastic, as shown in FIG. 9c).

A further special feature is shown in FIG. 9d. By means of locally different structuring of the penetration zones 14 (thicknesses differing from region to region), it is possible to obtain different opacities on one side, but it is also possible to permit, for example, characters for visually impaired persons in this way (locally different haptic properties). Such local penetration zones can be obtained, for example, by regionally different hot stamping.

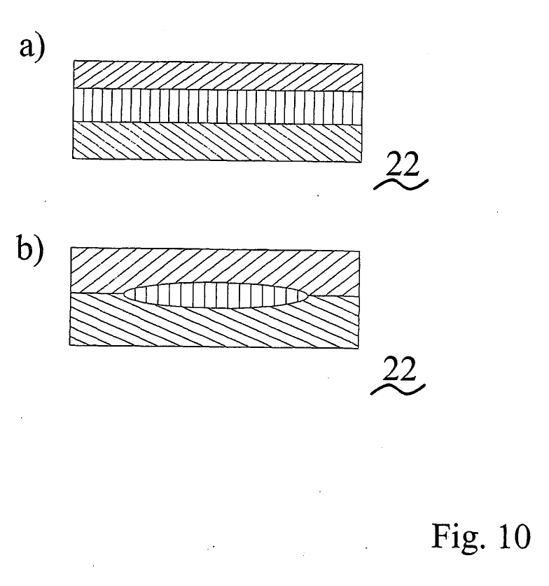

FIG. 10 serves to show that the plastic layer 22 can also be composed of a plurality of layers. These layers need not, as shown in FIG. 10a), extend over the entire area of the plastic layer 22 but, as shown in FIG. 10b, can also be present locally in the sense of inclusions (for example lenticular, strip-like, etc.).

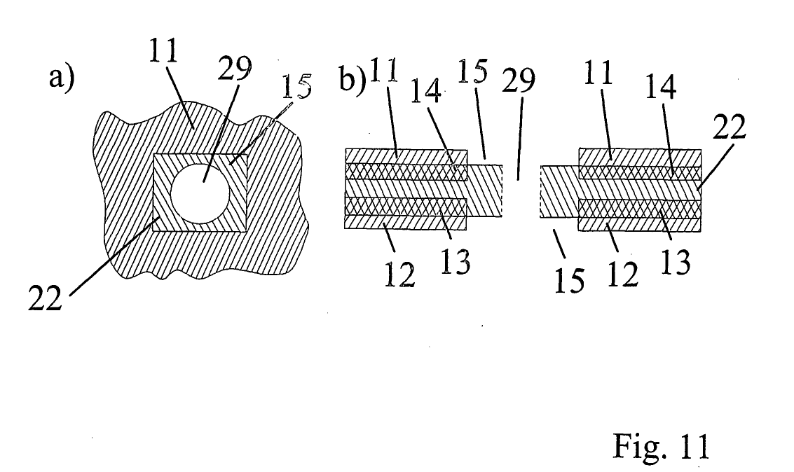

FIG. 11 shows that the plastic layer can in turn also be structured. For example, embossing, grids, etc. are possible. Here in particular a through-hole 28 is shown, as is conceivable, for example, in the case of a perforated document having an edge secured prior to tearing.

Further embodiments were produced and measured in order to illustrate the subject according to the invention. The following materials were used:

Paper:
Paper A: 80 g/m², recycled Xerox paper.
Paper B: 50 g/m², landquart, Landquart, Switzerland.
Paper C: 40 g/m², landquart, Landquart, Switzerland.
Paper D: 20 g/m², Velina Molto RU, Orema Spa; Orema.
Paper E: Kimwipes®, Kimberly-Clark Corp.

Polymers:
Grivory® G21 film, 30 μm thick (EMS Chemie, Switzerland),
Grilamid® TR 90 LX film, 30 μm and 60 μm thickness (EMS Chemie, Switzerland)
Grilamid® ELY 60 (EMS Chemie, Switzerland),
isotactic polypropylene Moplen® FLF20 (Basell Polyolefins Co. NV, Hoofdorp, NL),
Surlyn® K-based (E.I. DuPont De Nemours & Co., Wilmington, Del., USA),
Surlyn® Na-based (E.I. DuPont De Nemours & Co., Wilmington, Del., USA),
nylon 11 (Polysciences, Inc., Warrington, Pa., USA),
Kynar® (Atochem North America, Inc., Philadelphia, Pa., USA),
poly(ethylene-co-methyl acrylate) (Aldrich Chemical Co., Inc., Milwaukee, Wis., USA).

In general, the following processes were used:

Polymer films: The films were produced in a pressure melting process at the following temperatures:
Grilamid® ELY 60: 180° C.,
isotactic polypropylene: 200° C.,
Surlyn® K: 125° C.,
Surlyn® Na: 125° C.,
nylon 11: 200° C.,
Kynar®: 200° C.,
poly(ethylene-co-methyl acrylate): 125° C.

A Carver press, model M 25T, was used for this purpose. The applied pressure was 2 MPa during a time of 5 min, followed by cooling to room temperature. Films having a thickness of about 80 μm were obtained.

Paper/polymer/paper laminates: Layer structures comprising layers of paper/polymer/paper were assembled and were placed between two copper plates in the heated Carver press and initially left for 30 sec without application of pressure. Different pressures were then applied for different periods. The temperature during the pressure phase in the various example was in the range from 125° C. to 250° C. The examples were then cooled to room temperature.

Characterization: Tensile strength, modulus of elasticity and elongation at break of selected examples were determined from stress-strain diagrams which were obtained by tensile tests at room temperature (23° C.). An Instron tensile tester (model 4464) was used for this purpose. The sample length at the beginning was 12.5 mm, the width was 2 mm and the speed of the crosshead was 10 mm/min. Bursting pressure (DIN ISO 2758), breaking force, number of double folds (Tappi T423), tensile strength (DIN EN 21974) and stiffness (DIN 53121) were measured by standard methods for some selected samples, in each case according to the standard stated in brackets.

### EXAMPLE 1

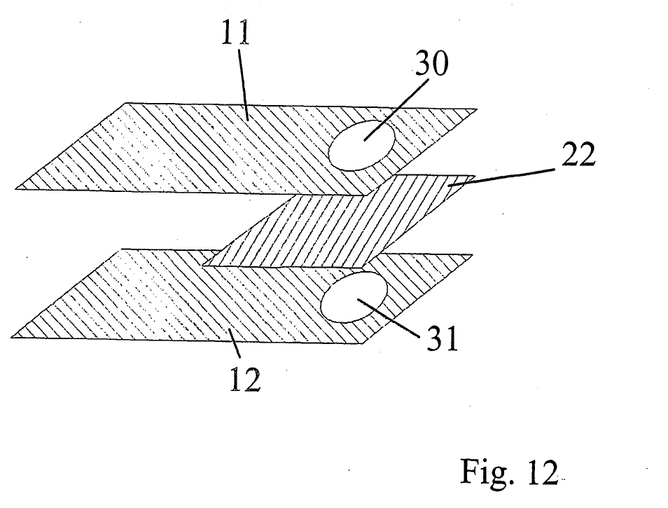

20 mm×100 mm samples of paper A were cut out, and a hole of 5 mm diameter was punched out in each case at one end of each piece. A piece of polymer film measuring 20 mm×40 mm×0.1 mm was then cut out and was placed between the two paper layers A, the two paper layers having been placed one on top of the other in such a way that the holes coincided (cf. FIG. 12). This layer structure was initially placed between two polyimide films in order to prevent adhesion to the copper plates of the press. The compression was then carried out for 2 min at 0.5 MPa for the various polymers at the following temperatures: Grilamid® TR 90 LX: 155° C. and 200° C., Surlyn® K: 125° C., Surlyn® Na: 125° C., nylon 11: 155° C. and 200° C., poly(ethylene-co-methyl acrylate): 125° C.

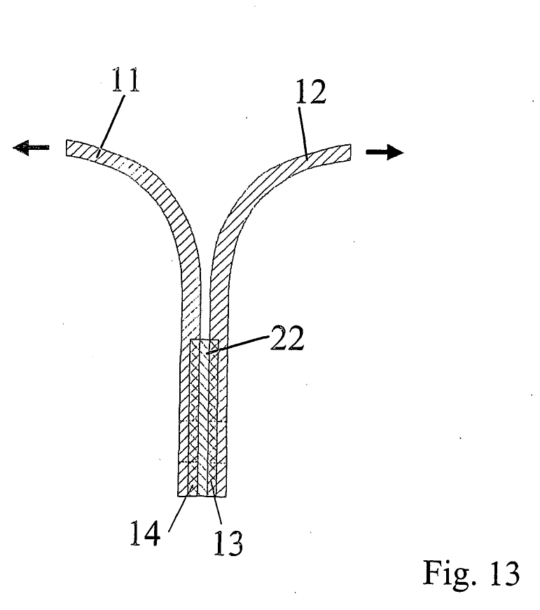

In all cases, a strong bond was obtained between the paper layers and the polymer. The two regions of the paper which were not bonded by the polymer layer were torn apart (cf. FIG. 13) this led in each of the cases to a tear within the paper layers (cohesion break in the paper) and not to delamination of the multiple layer laminate. The multiple layer laminate had a transparent polymer window in the region of the 2 windows of the paper layers.

### EXAMPLE 2

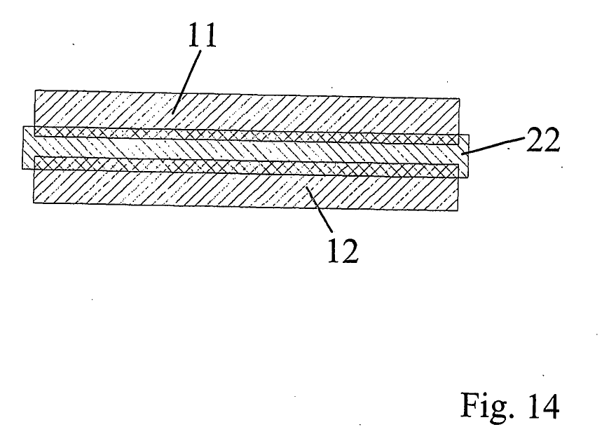

Example 1 was repeated, except that a larger piece of Grilamid® TR 90 LX measuring 24 mm×44 mm×0.1 mm was cut out. Once again, this piece was placed between two paper layers comprising paper A, a small region of the polymer film projecting in each case beyond the edge of the paper layers (FIG. 14). The presence of the resulting fusion region 23 in the region of the edge increased the tear resistance (particularly the initiation of the tear) of the corresponding multiple layer laminate dramatically when compared with example 1.

### EXAMPLE 3

Example 1 was repeated, but windows having a diameter up to 16 mm were produced instead of a window of 5 mm. In all cases, satisfactory multiple layer laminates having excellent mechanical properties were obtained.

### EXAMPLE 4

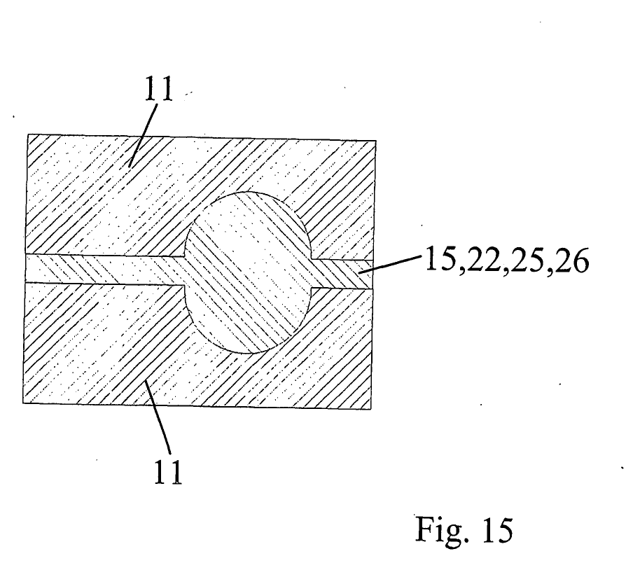

Example 1 was repeated, but a structure in which the two paper layers were not continuous was produced instead of a window of 5 mm (cf. FIG. 15). In these cases, too, satisfactory multiple layer laminates having good mechanical properties were obtained.

### EXAMPLE 5

Paper/polymer/paper laminates were produced as described under example 1, but with the use of paper B from Grilamid®TR 90 LX at 200° C. Thereafter, the multiple layer laminate was immersed in boiling water and kept there for 30 minutes with vigorous stirring. As a reference, a sheet of paper (paper B) was also exposed to the same conditions. This reference sheet decomposed completely under these conditions, whereas the multiple layer laminate remained intact and showed no delamination either during the treatment or thereafter.

### EXAMPLE 6

Paper C/Grivory® G21 30 μm film/paper D laminates measuring 80 mm×150 mm were produced as described under example 1, lamination being effected at 150° C. and 0.5 MPa for 1, 2 and 10 min. The tensile strength of the multiple layer laminates was then measured as stated above. Substantially no differences between the different multiple layer laminates were found, and tensile strengths of about 11 km were measured, which substantially corresponds to a value of paper D and is 50% higher than in the case of the polymer film alone and 30% higher than in the case of paper C. The various multiple layer laminates had different visual appearances and different surface structures. Thus, multiple layer laminates which had been produced in the lamination time of 10 min exhibited a polymer on the surface of the paper, which indicates that the molten polymer at least partly diffuses through the paper under these conditions. This manifested itself in a glossy appearance and in a smoother surface and in smoother haptic properties.

### EXAMPLE 7

80 mm×150 mm laminates of paper C/Grilamid® TR 90 LX 60 μm film/paper D (laminate I) and of paper C/Grilamid® ELY 60/paper D (laminate II) were produced as described under example 1, lamination being effected at 180° C. and a pressure of 0.75 MPa during a time of 1 min. A number of different parameters was measured using the methods described above. For comparison, the same properties were measured in the case of a paper as used in the production of a conventional 100 SFr. bank note (reference).

Test conditions: 23° C. and 50% relative humidity (test room conditions)

| Method | Property | Unit | Laminate I | Laminate II | Reference |
|---|---|---|---|---|---|
| DIN EN | Weight | g/m² | 109 | 105 | 91 |
| ISO 536 | | | | | |
| DIN EN | Thickness | μm | 116 | 119 | 113 |
| 20534 | | | | | |
| DIN EN | Spec. volume | cm³/g | 1.07 | 1.13 | 1.25 |
| 20534 | | | | | |
| DIN IS | Bursting | kPa | 415 | 300 | 360 |
| 2758 | pressure | | | | |
| DIN EN | Breaking | N | 145 | 87 | 106 |
| ISO | force-longit. | | | | |
| 1924-2 | | | | | |
| DIN EN | Breaking | N | 73 | 60 | 63 |
| ISO | force-transv. | | | | |
| 1924-2 | | | | | |
| Tappi | No. of folds- | — | 21 531 | 35 589 | 2162 |
| T 423 | longit. | | | | |
| Tappi | No. of folds- | — | 22 138 | >50 000 | 2088 |
| T 423 | transverse | | | | |
| DIN EN | Elmendorf | mN | 846 | 1133 | 1093 |
| 21974 | (1 sheet) - | | | | |
| | longit. | | | | |
| DIN EN | Elmendorf | mN | 942 | 974 | 1416 |
| 21974 | (1 sheet) - | | | | |
| | transv. | | | | |
| DIN | Stiffness, | Nmm | 1.32 | 0.48 | 0.56 |
| 53123 | beam-longit. | | | | |
| DIN | Stiffness, | Nmm | 0.54 | 0.59 | 0.25 |
| 53123 | beam-transv. | | | | |

The data show that the multiple layer laminates actually have outstanding properties, and in some respects surpass the properties of a bank note according to the prior art, for example with respect to the bursting pressure, the breaking force and the stiffness. Particularly remarkable is the increase or improvement in the values for the number of folds for the multiple layer laminate.

### EXAMPLE 8

Example 7 was repeated and multiple layer laminates comprising paper C/Grilamid® TR 90 LX 60 μm film/paper D were produced. They had a transparent window having a size of 10 mm×10 mm. A number of double folds was determined in a range in which the window was arranged. For this purpose, a test strip was cut out (or was positioned) so that the fold occurred in the window and in the surrounding paper (corresponding to Tappi T 423). The resulting value of the number of double folds was 7510.

### EXAMPLE 9

Example 8 was repeated and multilayer laminates comprising paper C/Grilamid® TR 90 LX 60 μm film/paper D were produced. They had a transparent window having a size of 10 mm×10 mm. The laminates were then subjected to a standard crumple test, an IGT crumpling tester being used 1, 4 or 8 times. The multiple layer laminates withstood these tests substantially unchanged, and no delamination was observed, even in the region of the windows. Moreover, the windows remained transparent.

### EXAMPLE 10

Example 9 was repeated, paper C containing a watermark this time while paper D had no watermark. The multiple layer laminate thus produced showed the watermark in paper C in surprising clarity and detectability. Surprisingly, the watermark appeared more sharply in the multiple layer laminate than was produced in paper C in the unlaminated state. This was particularly true on viewing in reflected light.

### EXAMPLE 11

Example 9 was repeated. In this test, the multiple layer laminate was subjected to a hot washing machine test, this test being carried out at a temperature of 95° C. for a time of 1 hour in 4 l of water, and 50 ml of a standard detergent (Omo) being added to this water. The multiple layer laminate withstood this test substantially unchanged, and no delamination was observed, even in the region of the window. The window withstood the test without becoming opaque.

### EXAMPLE 12

Aqueous dye solutions having a concentration of 0.25 mg/g of Congo Red (Aldrich Chemicals Co., Milwaukee) and Chicago Sky Blue (Sigma Chemical Co., St. Louis) were prepared by dissolving in each case 12.5 mg of the dye in 50 ml of distilled water. 10 g of polyvinyl alcohol (PVA, 98-99% hydrolyzed, weight average molecular weight of 10⁵ g/mol, Aldrich Chemicals Co., Milwaukee) were stirred for 2 h in 490 ml of boiling distilled water, a 2% w/w PVA solution being obtained. The solution was then allowed to cool to room temperature. Three PVA/dye blend films were produced by mixing a certain amount of corresponding dye solution with 10 g of the 2% w/w PVA solution, and the water was evaporated in a solution casting process in Petri dishes having a diameter of 9 cm at room temperature.

The films thus produced had the following compositions:
(A) 0.2% w/w Congo Red (based on solids content), prepared by mixing 1.6 g of Congo Red dye solution with 10 g of PVA solution,
(B) 0.4% w/w Chicago Sky Blue (based on solids content), prepared by mixing 3.2 g of Chicago Sky Blue dye solution with 10 g of PVA solution,
(C) 0.2% w/w Congo Red and 0.4% w/w Chicago Sky Blue (based on solids content), prepared by mixing 1.6 g of Congo Red dye solution and 3.2 g of Chicago Sky Blue dye solution with 10 g of PVA solution.

The dried PVA/dye blend films were cut into 2 cm wide strips and then uniaxially oriented on a hot shoe (Wagner & Munz, model WME) with a stretching ratio (ratio of the length after orientation to the length before orientation) of 6 at a temperature of 200° C. The polarizing filters obtained had dichroic ratios of more than 50 (determined at the absorption maxima in the spectrum) and had a thickness of, typically, 15 μm.

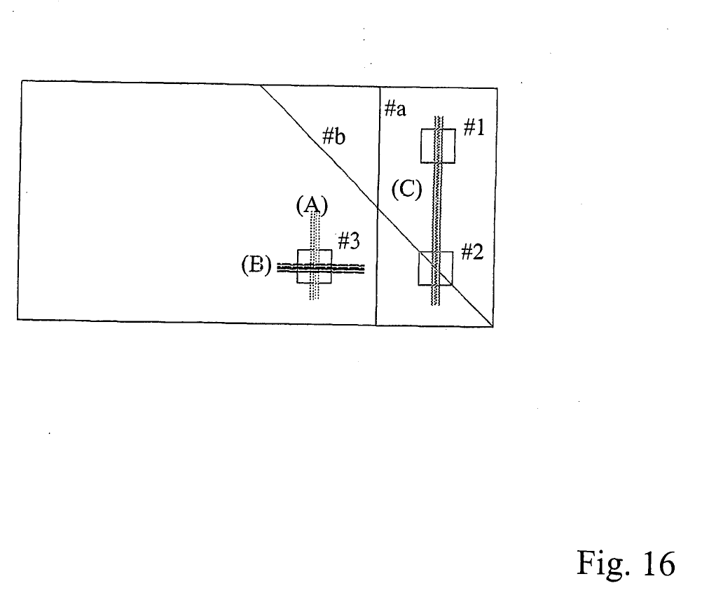

Multiple layer laminates having a size of 80 mm×150 mm and consisting of paper C and D, Grivory® G21 film having a thickness of 30 μm were produced using the dichroic filters described above (cf. FIG. 16, where (A), (B) and (C) relate to blend films of the above compositions). The following layer structure was built up:
1. a first layer of paper C having 3 holes having a size of 10 mm×10 mm;
2. a first layer of polymer film;
3. a strip of the dichroic filter (C) which covered both holes #1 and #2; a strip of the dichroic filter (A) which covered the hole #3 in such a way that its stretching direction is aligned parallel to the stretching direction of the strip (A);
4. a strip of the dichroic filter (B) on the layer of the dichroic filter (A), the hole #3 likewise being covered, and the strip (B) being oriented so that the stretching direction of the strip (B) was aligned perpendicular to the stretching direction of the strip (C);
5. a second layer of polymer film;
6. a second layer of paper D having holes at the corresponding points to enable a view through the entire multiple layer laminate.

The stack was laminated at a temperature of 120° C. during a time of 1 min and at a pressure of 0.5 MPa. Thus, a multiple layer laminate having three windows #1, #2 and #3 which all had a lavender gray color was obtained. When window #3 is viewed through the window #1 (by folding the multiple layer laminate along the line #a), the window #3 has a blue color. In contrast, a red coloration of window #3 is observed when window #3 is viewed through window #2 (by folding the multiple layer laminate along the line #b). Thus, a self-verifying object can be produced in a simple manner.

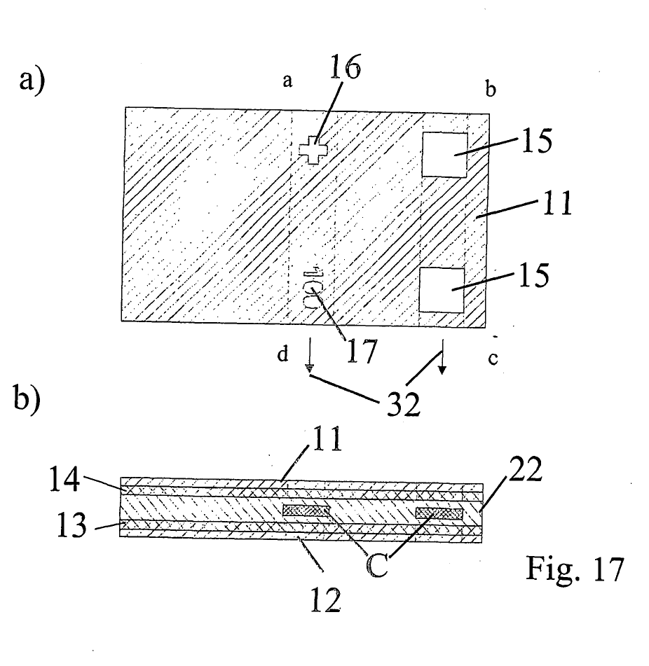

An object according to FIG. 17 can be produced in a similar manner. Here, two polarizing strips C are incorporated into the laminate, the layer structure analogous to the above example being obtained.

If the object is now folded so that the points a and c are placed on the points b and d, respectively, the cross and the number appear nontransparent and light gray. If, on the other hand, point a is folded onto point d, a black window appears as a result of the crossed polarization directions. The same applies to a folding of point c onto point b.

### EXAMPLE 13

Example 6 was repeated, but paper E was used on both sides of the various polymer films instead of the papers C and D. In this case too, excellent multiple layer laminates were obtained, which shows that such multiple layer laminates are obtainable using different papers.

### LIST OF REFERENCE NUMERALS

1 Security paper
2 Upper paper layer
3 Lower paper layer
4 Plastic layer
5 Adhesive, glue
10 Multiple layer laminate, e.g. security paper
11 Upper paper layer
12 Lower paper layer
13 Lower penetration zone
14 Upper penetration zone
15 Window (rectangular)
16 Window (shape)
17 Window (number)
18 Watermark
19 Security strip
20 Top
21 Bottom
22 Plastic layer (“side exposure”)
23 Edge fusion
24 Cut-out
25 Window, bordering the edge of the print substrate
26 Cut-out, bordering the edge of the print substrate
27 Further paper layer(s)
28 Further penetration zone(s)
29 Hole in 22
30 Hole in 11
31 Hole in 12
32 Polarization direction

1. A multiple layer laminate, in particular as a print substrate, for example as security paper, comprising:
at least one, optionally multilayer plastic layer (22) having a top side (20) and a bottom side (21);
at least one upper paper layer (11) bonded to the plastic layer (22) and present on the top side (20) of the plastic layer (22);
characterized in that the plastic layer (22) is a thermoplastic polymeric material, and in that the bond between the upper paper layer (11) and the plastic layer (22) is ensured substantially without additional adhesion promoter by a penetration zone (14) in which parts of the plastic layer (22) are fused to the material of the fiber composite of the paper layer (11), the penetration zones (13, 14) substantially not extending up to the surfaces of the paper layer which face away from the plastic layer (22).

2. The multiple layer laminate as claimed in claim 1, characterized in that at least one lower paper layer (12) bonded to the plastic layer (22) is arranged on the bottom side (21) of the plastic layer (22), and in that the bond between the lower paper layer (12) and the plastic layer (22) is ensured substantially without additional adhesion promoter by a penetration zone (13) in which parts of the plastic layer (22) are fused to the material of the fiber composite of the paper layer (12), the penetration zone (13) substantially not extending up to the surfaces of the paper layer which face away from the plastic layer (22).

3. The multiple layer laminate as claimed in claim 1, characterized in that at least one of the paper layers (11, 12) is paper which was produced in a vat machine or in a Fourdrinier machine, preferably with the use of cellulosic fiber material, such as cotton, and/or flax, and/or linen as the main fiber raw material.

4. The multiple layer laminate as claimed in claim 1, characterized in that the polymeric material has a glass transition temperature in the range from 50 to 250° C., preferably in the range from 75 to 225° C., or in the range from 100 to 200° C., particularly preferably from 120 to 180 degrees, or a flow temperature, if the glass transition temperature is below room temperature, in the range from 50 to 250° C., preferably in the range from 75 to 225° C., or in the range from 100 to 200° C., particularly preferably from 120 to 180 degrees.

5. The multiple layer laminate as claimed in claim 4, characterized in that the polymeric material is in particular a transparent or colored, preferably partly amorphous or completely amorphous polyamide, polypropylene or polyethylene, particularly preferably a polyamide based on aliphatic and cycloaliphatic building blocks, optionally with aromatic moieties.

6. The multiple layer laminate as claimed in claim 1, characterized in that the paper layers (11, 12) have a basis weight in the range from 5 to 500 g/m², preferably in the range from 10 to 80 g/m², particularly preferably in the range from 20 to 50 g/m², and in that the plastic layer (22) has a thickness in the range from 5 to 500 pm, preferably in the range from 10 or 20 to 80 pm, particularly preferably in the range from 20 to 50 pm, particularly preferably the resulting multiple layer laminate or the print substrate as a whole having a basis weight in the range from 15 to 1500 g/m², or from 50 to 500 g/m², preferably in the range from 80 to 180 g/m², or from 60 to 200 g/m², particularly preferably in the range from 90 to 120 g/m² or from 80 to 150 g/m².

7. The multiple layer laminate as claimed in claim 1, characterized in that the plastic layer (22) has at least one security feature, this security feature existing in the form of an electrical, electronic, magnetic or optical information medium or of a combination of such information media, preferably selected from: imprint, fluorescent region, polarizing region, polarized fluorescent region, polarized absorbent region, hologram, photochromic regions, microembossing, microperforation, chip, electrically conductive region, magnetic region.

8. The multiple layer laminate as claimed in claim 1, characterized in that at least one of the paper layers (11, 12) has a security feature, this security feature preferably being selected from: watermark, in particular gray step watermark (18); security filament (19); OVD; colored fibers; security pigments; iridescent color applications, chip, magnetic stripe.

9. The multiple layer laminate as claimed in claim 1, characterized in that at least one of the paper layers (11, 12) has a cut-out (15-17) right through so that the plastic layer (22) is exposed in this region, particularly preferably both paper layers (11, 12) having such a cut-out in an at least partly overlapping manner with formation of a window (15-17), particularly preferably having an irregular or fluid edge.

10. The multiple layer laminate as claimed in claim 9, characterized in that the plastic film has at least one security feature at least in the region of the window (15-17).

11. The multiple layer laminate as claimed in claim 10, characterized in that at least one further security feature, in particular having polarizing properties, can be checked with the aid of at least one window, in particular having polarizing properties.

12. The multiple layer laminate as claimed in claim 9, characterized in that a further plastic layer having the same contour as the window is inserted into the window in the region of the cut-out (15-17) during production.

13. The multiple layer laminate as claimed in claim 1, in particular in the form of a print substrate having a number of double folds which is more than twice as great as the number of double folds of an individual paper layer (11, 12), the number of double folds preferably being more than 5 times, particularly preferably more than 10 times or even more than 100 times as great as the number of double folds of an individual paper layer (11, 12).

14. The multiple layer laminate as claimed in claim 1, characterized in that at least one lower paper layer (12) bonded to the plastic layer (22) is arranged on the bottom side (21) of the plastic layer (22), and in that the bond between the lower paper layer (12) and the plastic layer (22) is ensured substantially without additional adhesion promoter by a penetration zone (13) in which parts of the plastic layer (22) are fused to the material of the fiber composite of the paper layer (12), the penetration zone (13) substantially not extending up to the surfaces of the paper layer (12) which face away from the plastic layer (22), and in that the multiple layer laminate has at least one edge which has, at least in sections, an edge fusion (23) which at least partly covers the lateral edge of at least one of the paper layers (11, 12), the edge fusion (23) preferably being formed from the material of the plastic layer (22).

15. The multiple layer laminate as claimed in claim 1, characterized in that the penetration depth (13, 14) is formed so that substantially at least 10 pm of that surface of at least one of the paper layers (11, 12) which faces away from the plastic layer (22) are substantially not penetrated by plastic.

16. The multiple layer laminate as claimed in claim 15, characterized in that the penetration depth (13, 14) is formed so that substantially at least 15 pm, preferably substantially at least 20 pm, particularly preferably substantially at least 30 pm, of that surface of at least one of the paper layers (11, 12) which faces away from the plastic layer (22) are substantially not penetrated by plastic.

17. The multiple layer laminate as claimed in claim 1, characterized in that the penetration depth (13, 14) has a thickness of at least 10 pm, preferably of at least 15 pm, particularly preferably of at least 30 pm.

18. The multiple layer laminate as claimed in claim 1, characterized in that the penetration depth (13, 14) has a different thickness in regions.

19. The multiple layer laminate as claimed in claim 1, characterized in that the plastic layer (22) is formed so as to be polarizing and/or fluorescent and/or phosphorescent and/or optically refractive, particularly preferably polarized absorption and/or polarized emission being present.

20. A print substrate, packaging material, covering material, security paper, in particular bank note, check, ticket, certificate, share document, bond document, document, identity document or admission document produced starting from a multiple layer laminate as claimed in claim 1.

21. A process for the production of a multiple layer laminate, in particular of a print substrate, as claimed in claim 1, characterized in that the paper layers (11, 12) are at least partly fused to the plastic layer (22) in a laminator, a temperature in the range from 50 to 250° C., preferably in the range from 75 to 225° C., or in the range from 100 to 200° C., particularly preferably from 140 to 180° C., being used, and a pressure in the range from 10 Pa to 10 MPa, preferably from 1 kPa to 10 MPa, of from 1 kPa to 5 MPa, particularly preferably in the range from 0.5 MPa to 2 MPa, being used.

22. The process as claimed in claim 21, characterized in that the temperature is initially increased from room temperature to the target temperature and then the pressure is increased from atmospheric pressure to the target pressure.

23. The process as claimed in claim 21, characterized in that it is a continuous process in which the individual substrates (11, 12, 22) are fed by rollers, and in that the laminator is a roller laminator, the plastic layer (22) being fed centrally and the two paper layers (11, 12) from the top and the bottom, and particularly preferably a nip pressure in the range from 1 to 500 N/mm being used.

24. The process as claimed in claim 21, characterized in that a stretched film having polarizing properties is used as plastic layer (22), at least in regions.

25. The process as claimed in claim 21, characterized in that the multiple layer laminate is cut to size and/or aftertreated, in particular subsequently locally laminated, in such a way that an edge fusion (23) is formed in the region of at least one edge.

26. The process as claimed in claim 25, characterized in that the edge fusion (23) is produced by applying an elevated temperature and/or an elevated pressure in the cutting region during cutting.

27. The use of a multiple layer laminate or of a print substrate as claimed in claim 1 as covering material, packaging material, card material, security paper, in particular as a bank note, check, ticket, certificate, share document, bond document, documents, identity documents or admission documents.
